(19) United States
(12) Patent Application Publication
(10) Pub. No.: US 2012/0036084 A1
(43) Pub. Date: Feb. 9, 2012

(54) METHOD AND SYSTEM FOR RATING ITEMS

(75) Inventors: Mauro Barbieri, Eindhoven (NL); Serverius Petrus Paulus Pronk, Eindhoven (NL)

(73) Assignee: KONINKLIJKE PHILIPS ELECTRONICS N.V., EINDHOVEN (NL)

(21) Appl. No.: 13/265,187

(22) PCT Filed: Apr. 13, 2010
(86) PCT No.: PCT/IB10/51589

§ 371 Date: Oct. 19, 2011

(30) Foreign Application Priority Data
Apr. 20, 2009 (EP) 09158199.1

(51) Int. Cl. G06Q 30/02

(52) U.S. Cl. 705/347

(57) ABSTRACT

Items are rated for use in a recommender. A record of a plurality of previously rated items and their associated ratings is maintained and upon receiving a rating for a first item (201), at least one of the rated items is retrieved (205) having a similar rating to the rating of the first item. The retrieved at least one rated items is displayed (207). The user may then change rating of the first item or the retrieved items (209) in order to apply the ratings consistently.

### FIELD OF THE INVENTION

The present invention relates to method and system for rating items. In particular, but not exclusively, it relates to rating items for recommender systems to enable the system to learn user's preferences.

### BACKGROUND OF THE INVENTION

Recommenders are becoming increasingly popular as tools to retrieve, from a vast amount of items such as audio/video content repositories, product catalogues, and the like, only those items a user (or a group of users) likes. These recommenders are typically offered as a stand-alone service (e.g. Movielens), or as an add-on to an existing service (e.g. Amazon, iTunes). They increasingly appear in consumer devices, such as the TiVo DVR.

These recommender systems require feedback from the users to learn their tastes. Typically, users are asked to rate items on a given discrete scale, often a five, seven or eleven point scale.

Explicitly rating items on a five, seven or eleven point scale can be a challenge for many users. It is very difficult to rate items consistently over time. An item might receive a 5 on a seven point scale one day, and another day another item which is not more appreciated, might receive a 6 while, to be consistent, it should have received a 5. At the time of rating the second item, the user may not be aware of how he has previously rated similar items.

Inconsistent ratings can lead to poor recommendations, mistrust in the recommender and eventually high user dissatisfaction.

Another problem of discrete scales is that users' tastes and rating criteria evolve over time. An item that has received a 5 on a five point scale, might obtain only a 4 after a few months. It is not feasible to ask users to re-rate items continuously. It would be desirable to have a system that can support the natural evolution of a user's taste.

### SUMMARY OF THE INVENTION

The present invention seeks to provide a system for rating items in which user consistency is improved.

This is achieved according to a first aspect of the present invention by a method of rating items, the method comprising the steps of: maintaining a record of a plurality of rated items of a user and associated ratings; receiving a rating for a first item; selecting at least one of the plurality of rated items of the record having a similar rating to the received rating of the first item; and presenting the selected at least one of the plurality of rated items.

This is also achieved according to a second aspect of the present invention by a system for rating items, the system comprising: storage means for maintaining a record of a plurality of rated items of a user and associated ratings; an interface device for receiving a rating for a first item; and processor means for selecting at least one of the plurality of rated items of the record having a similar rating to the received rating of the first item and presenting the selected at least one of the plurality of rated items and its associated rating on a display.

Upon rating an item, the user is shown the items he has rated with a similar rating. In this way, the user can rate items consistently, allowing the recommender to provide good recommendations. Additionally, the user can review at a glance previously rated items and revise these to make them more consistent with his/her current taste.

For example, in a particular embodiment of a mouse-based user interface with a five point scale (e.g. Microsoft Media Player has a 5 stars rating system), when the mouse pointer is on the score 5, the interface shows the latest and most similar 3-5 items that have received a 5 stars score.

In this way, the user can rate items consistently, allowing the recommender to provide good recommendations. Additionally, the user can review at a glance older items and revise the older ratings to make them more consistent with his/her current taste.

In an embodiment the rating of the presented, selected at least one of the plurality of rated items may be updated by, for example, receiving a new rating for at least one of the selected at least one of the plurality of rated items or receiving confirmation of the rating of the first item to update the record history of rated items. In this way previously rated items can be updated to take into account the user's changes in taste etc.

The at least one of the plurality of rated items may be selected by determining the degree of similarity between the first item and each of the plurality of rated items of the record; determining the degree of similarity of the rating of the first item and each of the plurality of rated items of the record; selecting at least one of the plurality of rated items on the basis of the highest determined degree of similarity between the first item and each of the plurality of rated items of the record and on the basis of the highest determined degree of similarity of the rating of the first item and each of the plurality of rated items of the record. For example determining the distance between an attribute value of at least one attribute of the first item and an attribute value of a corresponding attribute of each of the plurality of rated items of the record; and selecting items from the plurality of rated items of the record having a distance within a predetermined threshold. This provides a simple, yet effective, technique of selecting relevant, previously rated items to the user to make comparisons, and possible updates, easier.

### BRIEF DESCRIPTION OF DRAWINGS

For a more complete understanding of the present invention, reference is made to the following description in conjunction with the accompanying drawings, in which:

FIG. 1 is simple schematic of the system according to an embodiment of the present invention; and

FIG. 2 is a flowchart of the method of rating items according to an embodiment of the present invention.

### DETAILED DESCRIPTION OF AN EMBODIMENT OF THE INVENTION

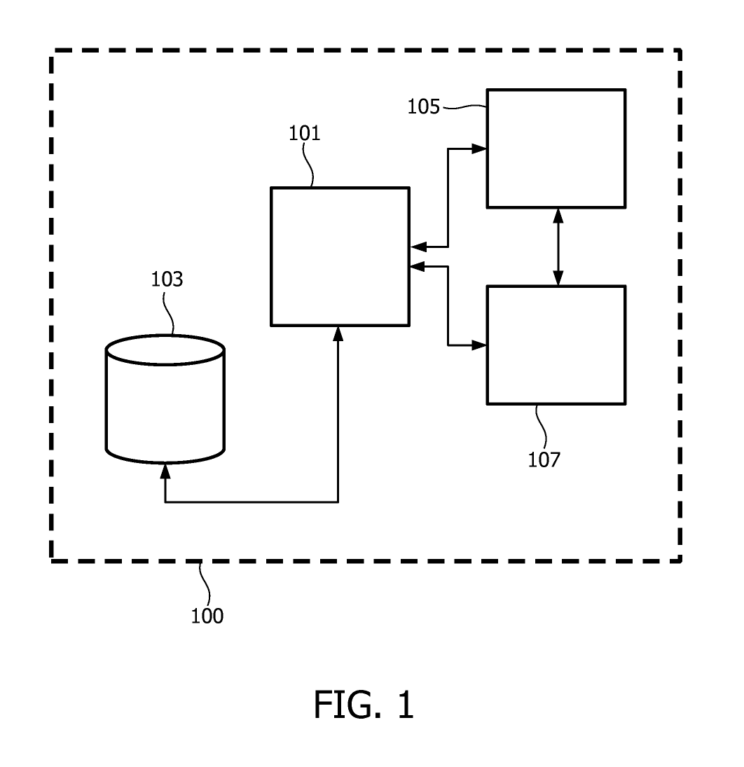

The system 100 of an embodiment of the present invention, as shown in FIG. 1, comprises a processor means 101 connected to a storage means 103. The storage means 103 may be a memory integral with the processor means 101 or a separate memory means such as a CD-ROM or an external storage means such as a library maintained on a server and accessed remotely over the internet for example. The processor means 101 is also connected to an interface device 105 and a display 107. The interface device 105 may be a remote control device or mouse which allows user interaction with the display 107. Alternatively, the interface device may comprise a touch sensitive screen, keypad or the like. The display may be a television screen, computer screen or screen of a handheld device such as a PDA, mobile telephone, MP3 or the like.

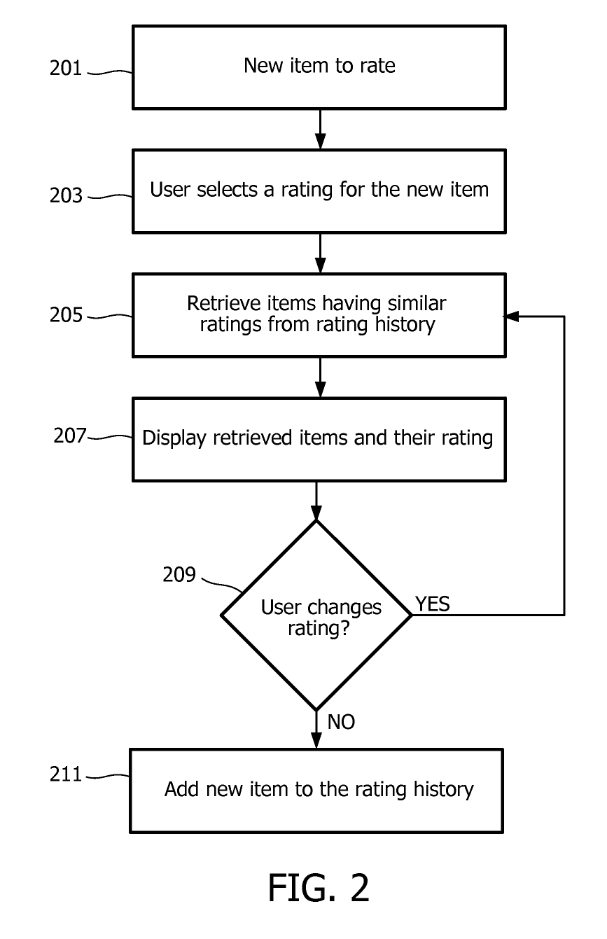

Operation of the system will now be described in detail with reference to FIG. 2. When a new item is available for rating, step 201, it is presented to the user on the display 107. The item may be or may represent a multimedia item such a music track that has been purchased and downloaded by the user. The user is also presented with a scale, usually in the form of a number of stars, for example 5, 7 or 11 stars. The user uses the stars to select a rating of the new item, step 203, using the interface device 105. The processor means 101 then retrieves items from a record maintained in the storage means 103. The record comprises a rating history of items, for example, a table containing the items previously rated by the user with corresponding ratings. Items are retrieved that have a rating similar to the rating given to the new item. Thus, the items are retrieved irrespective of the similarity between the items. This allows the user to review how this rating has been applied to a broad range of items. Alternatively, it may retrieve items similar to the new item or retrieve an item on the basis of how recently an item was rated or any combination of the above. Alternatively, randomly chosen items may be retrieved, for example.

Each item has associated a set of descriptive information called metadata. Examples of metadata for video items are: genre, title, director, cast, etc. These attributes have associated values and a distance measure between the attribute values is determined and those items having a distance measure within a predetermined threshold are selected. The distance measures for an attribute may be defined depending on the type of attribute. The items may be selected if they have the same rating or a rating within a predetermined range of the rating of the new item. The ratings may also be time stamped and the most recently rated items can be retrieved. In an alternative embodiment, instead of retrieving the most recently rated items, rated items are retrieved more evenly distributed over the entire rating history. As a result more long-term consistency rather than short-term consistency is realised.

The selected items retrieved from the storage means are then presented to the user with their current associated ratings, step 207, on the display 107. For example, from the retrieved list of items similar to the new item to rate, the top 3 (or 5) are shown in the user interface to allow the user to compare his/her rating with his/her previous ratings. If the user decides to change his/her rating, step 209, a new list is retrieved, step 205, and displayed, step 207, similar to the new rating. The process is repeated until the user confirms his/her rating for the new item. At this point, the new item and its rating are added to the rating history, step 211.

During the process, the user can select one of the similar items retrieved from the rating history, and review and change its ratings. To change the rating of a previously rated item, the same procedure used for rating new items can be used.

The invention can be applied to (Internet-enabled) TV sets, PVRs, set-top boxes, audio systems (including portable audio), and services (including Internet video and music services) where recommenders are used.

Although embodiments of the present invention have been illustrated in the accompanying drawings and described in the foregoing detailed description, it will be understood that the invention is not limited to the embodiments disclosed, but is capable of numerous modifications without departing from the scope of the invention as set out in the following claims.

‘Means’, as will be apparent to a person skilled in the art, are meant to include any hardware (such as separate or integrated circuits or electronic elements) or software (such as programs or parts of programs) which reproduce in operation or are designed to reproduce a specified function, be it solely or in conjunction with other functions, be it in isolation or in co-operation with other elements. The invention can be implemented by means of hardware comprising several distinct elements, and by means of a suitably programmed computer. In the apparatus claim enumerating several means, several of these means can be embodied by one and the same item of hardware. ‘Computer program product’ is to be understood to mean any software product stored on a computer-readable medium, such as a floppy disk, downloadable via a network, such as the Internet, or marketable in any other manner.

1. A method of rating items, the method comprising the steps of:
maintaining a record of a plurality of rated items of a user and associated ratings;
receiving a rating for a first item;
selecting at least one of said plurality of rated items of said record having a similar rating to said received rating of said first item; and
presenting said selected at least one of said plurality of rated items.

2. A method according to claim 1, further comprising the step of:
allowing the rating of said selected at least one of said plurality of rated items to be updated.

3. A method according to claim 2, wherein the step of allowing the rating of said selected at least one of said plurality of rated items to be updated comprises the step of:
receiving a new rating for at least one of said selected at least one of said plurality of rated items.

4. A method according to claim 3, wherein the method further comprises the step of:
updating said record of said plurality of rated items by updating said at least one of said selected at least one of said plurality of rated items with said received new rating.

5. A method according to claim 1, wherein the method further comprises the steps of:
confirming a rating for said first item, and adding said first item and its confirmed rating to said record of the plurality of rated items.

6. A method according to claim 1, wherein the step of selecting at least one of said plurality of rated items comprises the step of
selecting at least one of said plurality of rated items similar to said first item.

7. A method according to claim 6, wherein the step of selecting at least one of said plurality of rated items comprises the steps of:
determining the degree of similarity between said first item and each of said plurality of rated items of said record;
determining the degree of similarity of the rating of said first item and each of said plurality of rated items of said record;
selecting at least one of said plurality of rated items on the basis of the highest determined degree of similarity between said first item and each of said plurality of rated items of said record and on the basis of the highest determined degree of similarity of the rating of said first item and each of said plurality of rated items of said record.

8. A method according to claim 7, wherein the step of determining the degree of similarity between said first item and each of said plurality of rated items of said record comprises the steps of:
determining the distance between an attribute value of at least one attribute of said first items and an attribute value of a corresponding attribute of each of said plurality of rated items of said record; and
selecting items from said plurality of rated items of said record having a distance within a predetermined threshold.

9. A method according to claim 1, wherein the step of selecting at least one of said plurality of rated items further comprises the step of:
selecting at least one of said plurality of rated items on the basis of the most recently rated items.

10. A computer program product comprising a plurality of program code portions for carrying out the method according to any claim 1.

11. A system for rating items, the system comprising:
a storage for maintaining a record of a plurality of rated items of a user and associated ratings;
an interface device for receiving a rating for a first item; and
a processor for selecting at least one of said plurality of rated items of said record having a similar rating to said received rating of said first item and presenting said selected at least one of said plurality of rated items and its associated rating on a display.

12. A system according to claim 11, wherein said interface device allows the rating of said selected at least one of said plurality of rated items to be updated.

13. A system according to claim 11, wherein said processor is capable of selecting at least one of said plurality of rated items of said record similar to said first item.

14. A system according to claim 12, wherein said interface device is capable of receiving a new rating for at least one of said selected at least one of said plurality of rated items.

15. A system according to claim 14, wherein said processor is capable of updating the record, stored in said storage, of said at least one of said selected at least one of said plurality of rated items with said received new rating.
